(19) United States
(12) Patent Application Publication
(10) Pub. No.: US 2006/0010782 A1
(43) Pub. Date: Jan. 19, 2006

(54) Width-adjustable shade cloth and Roman shade using same

(76) Inventors: Ming Nien, Changhua Hsien (TW); David Kuei-Tin Pon, Irvine, CA (US)

Correspondence Address: BIRCH STEWART KOLASCH & BIRCH, PO BOX 747, FALLS CHURCH, VA, 22040-0747, US

(21) Appl. No.: 10/901,133

(22) Filed: Jul. 29, 2004

(30) Foreign Application Priority Data
Mar. 12, 2004 (TW) 093203865

(51) Int. Cl. B62D 63/04

(52) U.S. Cl. 52/3

(57) ABSTRACT

A shade cloth for use in a Roman shade includes a cloth body and a plurality of coupling units provided at a back side of the cloth body at different elevations adjacent to one lateral side edge of the cloth body for securing the respective lateral side edge of the cloth body to the back side of the cloth body so as to adjust the transverse length of the cloth body. The present invention relates also to a Roman shade having a retractable headrail and the shade cloth connected to and suspended from the headrail.

### BACKGROUND OF THE INVENTION

1. Field of the Invention

The present invention relates to a shade cloth for a Roman shade and more particularly, to a width-adjustable shade cloth for a Roman shade. The invention relates also to a Roman shade using a retractable headrail and the width-adjustable shade cloth.

2. Description of the Related Art

Roman shade manufacturers provide limited sizes of Roman shades for selection. When purchasing a Roman shade, the user can only select the size that is slightly greater than the width (transverse length) of the window, and then use a cutting tool to cut one lateral side of the Roman shade subject to the size of the window, and then install the well-cut Roman shade in the window. This installation procedure is workable. However, the user must measure the size of the window before selecting the desired Roman shade. After selection of the desired Roman shade, the user must cut the Roman shade to fit the size of the window. If the selected Roman shade is improperly cut, a secondary cutting procedure may be needed. If the Roman shade is cut too far, the Roman shade become unable to shade the whole area of the window, and the user shall share the loss. Further, the distributor or sales center shall provide a cutting machine for the consumers to cut selected Roman shades. The installation of such a cutting machine is expensive. Training of workers to use the cutting machine greatly increases the labor cost. The distributor or sales center shall bear the loss of a defective Roman shade due to an improper cut by a worker of the distributor or sales center.

### SUMMARY OF THE INVENTION

It is the primary objective of the present invention to provide a shade cloth for a Roman shade, which has the lateral side thereof inwardly fordable so that the user can conveniently adjust the width (transverse length) of the shade cloth to fit different sizes of windows.

To achieve this objective of the present invention, the shade cloth for a Roman shade comprises a cloth body having a front side, a back side and two opposite lateral side edges, and a coupling unit provided at the back side of the cloth body adjacent to one of the two opposite lateral side edges for securing the respective one of the two opposite lateral side edges to the back side of the cloth body so as to adjust transverse length of the cloth body.

It is another objective of the present invention to provide a width-adjustable Roman shade that can conveniently be adjusted to fit different sizes of windows. The Roman shade provided by the present invention comprises a retractable headrail and the above-mentioned shade cloth connected to and suspended from the headrail.

In a preferred embodiment of the present invention, the coupling unit is formed of a male snap element and a plurality of female snap elements transversely aligned with the male snap element and connectable to the male snap element.

In another preferred embodiment of the present invention, the coupling unit comprises a first coupling element and a second coupling element that is aligned transversely with the first coupling element and is connectable to the first coupling element. Preferably, the first coupling element and the second coupling element are respectively hook and loop tapes of a hook and loop fastener.

### BRIEF DESCRIPTION OF THE DRAWINGS

FIG. 1 is a front view of a width-adjustable Roman shade according to a first preferred embodiment of the present invention.

FIG. 2 is a rear side view of the width-adjustable Roman shade according to the first preferred embodiment of the present invention.

FIG. 3 is a sectional view taken along line 3-3 of FIG. 1, showing the locking device locked the second headrail element to the first headrail element of the retractable headrail.

FIG. 4 is an enlarged view of a part of FIG. 1 showing the method of connection of the shade body to the headrail.

FIG. 5 is an exploded view of a support rod for the width-adjustable Roman shade according to the first preferred embodiment of the present invention.

FIG. 6 is a schematic front view of the first preferred embodiment of the present invention, showing an adjustment status of the width-adjustable Roman shade.

FIG. 7 is a front view of a width-adjustable Roman shade according to a second preferred embodiment of the present invention.

FIG. 8 is a rear side view of the width-adjustable Roman shade according to the second preferred embodiment of the present invention.

FIG. 9 is a front view of a width-adjustable Roman shade according to a third preferred embodiment of the present invention.

FIG. 10 is a rear side view of the width-adjustable Roman shade according to the third preferred embodiment of the present invention.

FIG. 11 is an elevational view of a support rod for the width-adjustable Roman shade according to the third preferred embodiment of the present invention.

### DETAILED DESCRIPTION OF THE INVENTION

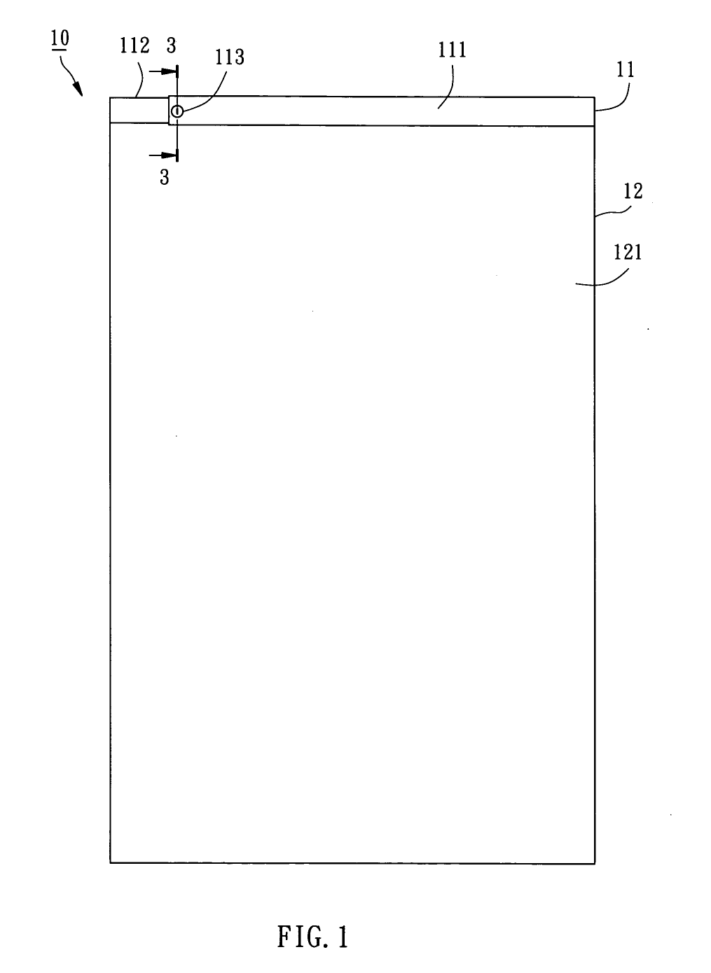

Referring to FIGS. 1-6, a width-adjustable Roman shade 10 in accordance with the first preferred embodiment of the present invention is shown comprising a retractable headrail 11, a shade cloth 12, a plurality of support rods 13, two lift cords 14, a plurality of coupling units 15, and a fastening unit 16.

The headrail 11 is installed in the top side of the window (not shown). The fabric shade cloth 12 comprises a cloth body 121 fixedly fastened to the bottom side of the headrail 11, a plurality of elongated pockets 122 transversely provided at the back side of the cloth body 121 at different elevations (according to this embodiment, the number of the pockets 122 is 7), and a plurality of cord-guiding loops 123 respectively provided at the pockets 122 on the outside and arranged into two vertical lines. The support rods 13 are respectively inserted into the pockets 122 to support the cloth body 121 transversely (horizontally) in shape. The lift cords 14 each have one end tied to the lowest one of one of the two vertical lines of the cord-guiding loops 123 and the other end inserted through the others of the respective vertical line of the cord-guiding loops 123 and then coupled to the headrail 11 for controlling lifting and lowering of the bottom side of the cloth body 121.

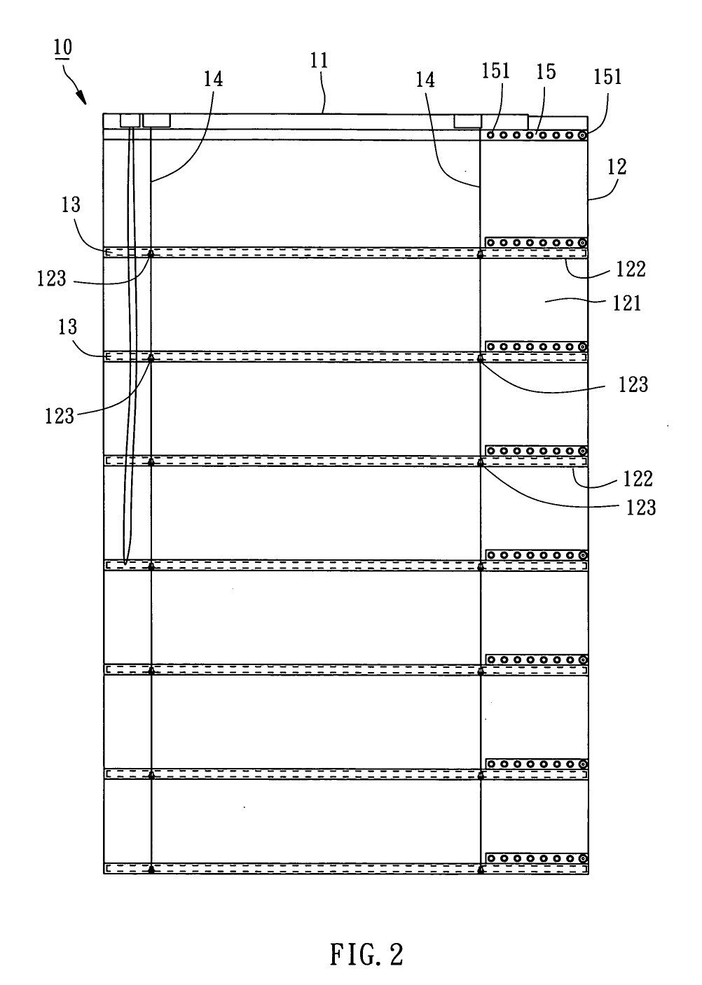

Referring to FIG. 2 again, the coupling units 15 are transversely provided at the back side of the cloth body 121 at different elevations near one lateral side (according to this embodiment, the number of the coupling units 15 is 8 wherein one coupling units 15 is provided at the top side of the cloth body 121 and the other coupling unit units 15 are respectively provided corresponding to the pockets 122). Each coupling unit 15 is comprised of a male snap element 151 provided near one lateral side edge of the cloth body 121 and a plurality of female snap elements 152 transversely aligned with the male snap element 151 in a line. By means of turning one lateral side edge of the cloth body 121 backward to fasten the male snap element 151 of each coupling unit 15 to one respective female snap element 152, the width (transverse length) of the shade cloth 12 is relatively adjusted.

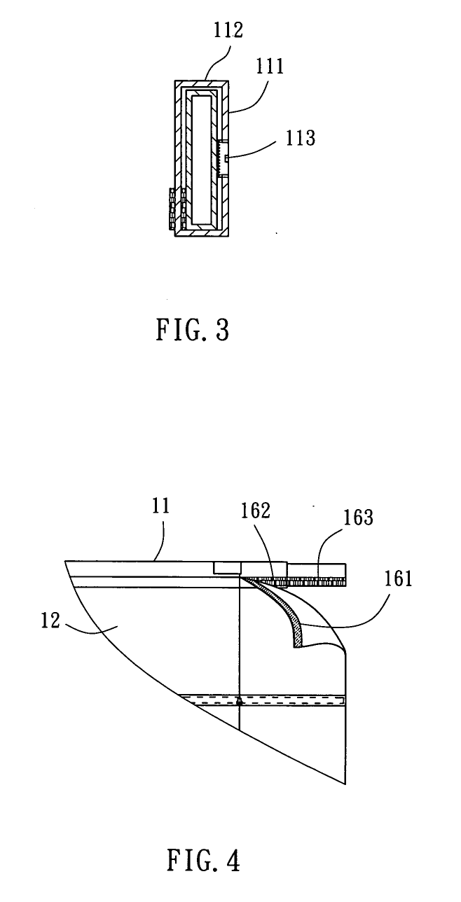

Referring to FIGS. 3 and 4, the headrail 11 comprises a first headrail element 111, a second headrail element 112, and a locking device 113. The first headrail element 111 and the second headrail element 112 are narrow elongated elements. The first headrail element 111 has an internal contour fitting the external contour of the second headrail element 112 such that the second headrail element 112 is axially movable in and out of the first headrail element 111. The locking device 113 according to this embodiment is a tightening up screw perpendicularly mounted in the peripheral wall of the first headrail element 111 and stoppable against the periphery of the second headrail element 112 to hold down the second headrail element 112 in position by means of friction resistance.

The fastening unit 16, as shown in FIG. 4, is comprised of a first fastener 161, a second fastener 162, and a third fastener 163. The second fastener 162 and the third fastener 163 are connectable to the first fastener 161, i.e., the first fastener 161 can be a male fastening member (or female fastening member) and the second fastener 162 and third fastener 163 can be female fastening members (or male fastening members) connectable to the first fastener 161. Preferably, hook and loop tapes of a hook and loop fastener are used for the fasteners 161-163, i.e., the first fastener 161 can be a hook tape of the hook and loop fastener (or loop tape of the hook and loop fastener), and the second and third fasteners 162, 163 can be loop tapes (or hook tapes). The first fastener 161 is provided at the front surface of the cloth body 121 and extended along the top side edge of the cloth body 121. The second fastener 162 is provided at the back side of the first headrail element 112 and longitudinally (axially) extended along the length of the first headrail element 112. The third fastener 163 is provided at the back side of the second headrail element 113 and longitudinally (axially) extended from one end (the outer end) of the second fastener 113 toward the other end (the inner end) of the second fastener 113 to a distance.

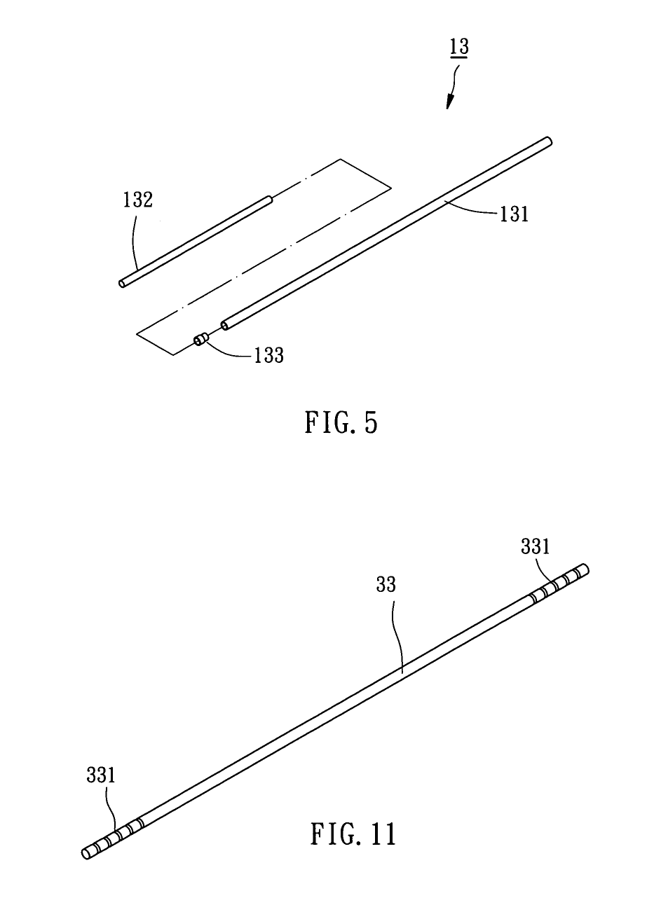

Referring to FIG. 5, the support rods 13 are retractable rod members each comprised of a tubular outer rod element 131, an inner rod element 132, and an elastic socket member 133. The elastic socket member 133 is provided at one end of the tubular outer rod element 131. The inner rod element 132 is inserted through the elastic socket member 133 into the inside of the tubular outer rod element 131 and axially movable relative to the tubular outer rod element 131 to adjust the length of the respective support rod 13. After each adjustment, the friction resistance between the elastic socket member 133 and the inner rod element 132 locks the respective support rod 13 to the adjusted length.

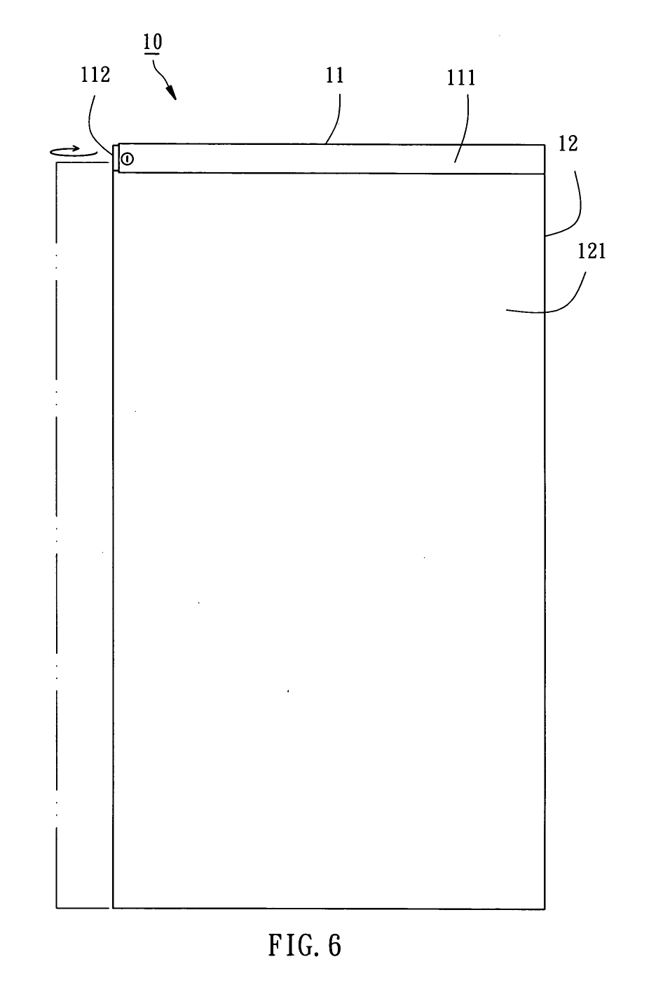

When adjusting the width (transverse length) of the Roman shade 10, extend or receive the rod members 13 to the desired length, and then unfasten the fastening unit 16 to detach the shade cloth 12 from the headrail 11, and then turn the respective lateral side edge of the cloth body 121 backward to fasten the male snap elements 151 of the coupling units 15 to selected respective female snap elements 152 so as to adjust the width (transverse length) of the shade cloth 12, and then adjust the length of the headrail 11 subject to the adjusted width (transverse length) of the shade cloth 12, and then fasten the first fastener 161 to the second fastener 162 and third fastener 163 to secure the shade cloth 12 to the headrail 11, as shown in FIG. 6.

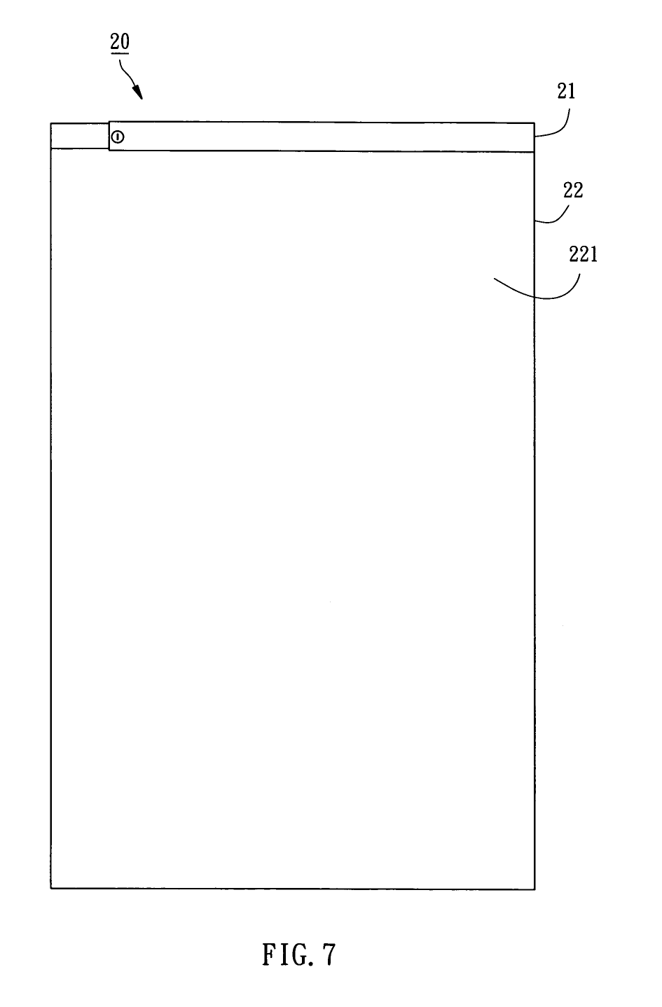

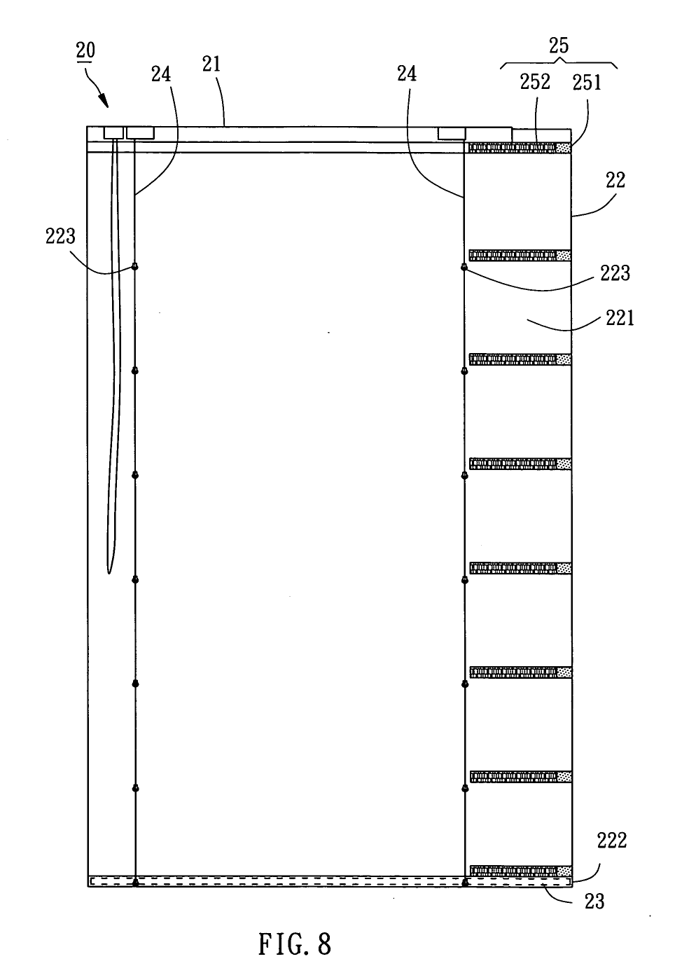

FIGS. 7 and 8 show a width-adjustable Roman shade 20 constructed according to the second preferred embodiment of the present invention. The width-adjustable Roman shade 20 comprises a headrail 21 installed in the top side of the window (not shown), a shade cloth 22, which comprises a cloth body 221, an elongated pocket 222 transversely provided at the back side of the cloth body 221 and extended along the bottom side of the cloth body 221 and a plurality of cord-guiding loops 223 respectively provided at the back side of the cloth body 221 and arranged into two vertical lines, a support rod 23 inserted into the pocket 222 to support the cloth body 221 transversely (horizontally) in shape, two lift cords 24 each having one end tied to the lowest one of one of the two vertical lines of the cord-guiding loops 223 and the other end inserted through the others of the respective vertical line of the cord-guiding loops 223 and then coupled to the headrail 21 for controlling lifting and lowering of the bottom side of the cloth body 221, and a plurality of coupling units 25 transversely provided at the back side of the cloth body 221 at different elevations near one lateral side.

The headrail 21, support rod 23 and lift cords 24 of this second embodiment are substantially similar to those of the aforesaid first embodiment. The main feature of this second embodiment is outlined hereinafter. As illustrated in FIG. 8, the coupling units 25 are formed of hook and loop fasteners, each comprised of a narrow short first coupling element 251, e.g. a short hook tape of the hook and loop fastener, provided at the back side of the cloth body 221 near one lateral side edge of the cloth body 221 and a narrow long second coupling element 252, e.g. a long loop tape of the hook and loop fastener, transversely provided at the back side of the cloth body 221 and aligned with the narrow short first coupling element 251 in a line. By means of turning one lateral side edge of the cloth body 221 backward to fasten the narrow short first coupling element 251 of each coupling unit 25 to the respective narrow long second coupling element 252, the width (transverse length) of the shade cloth 22 is relatively adjusted.

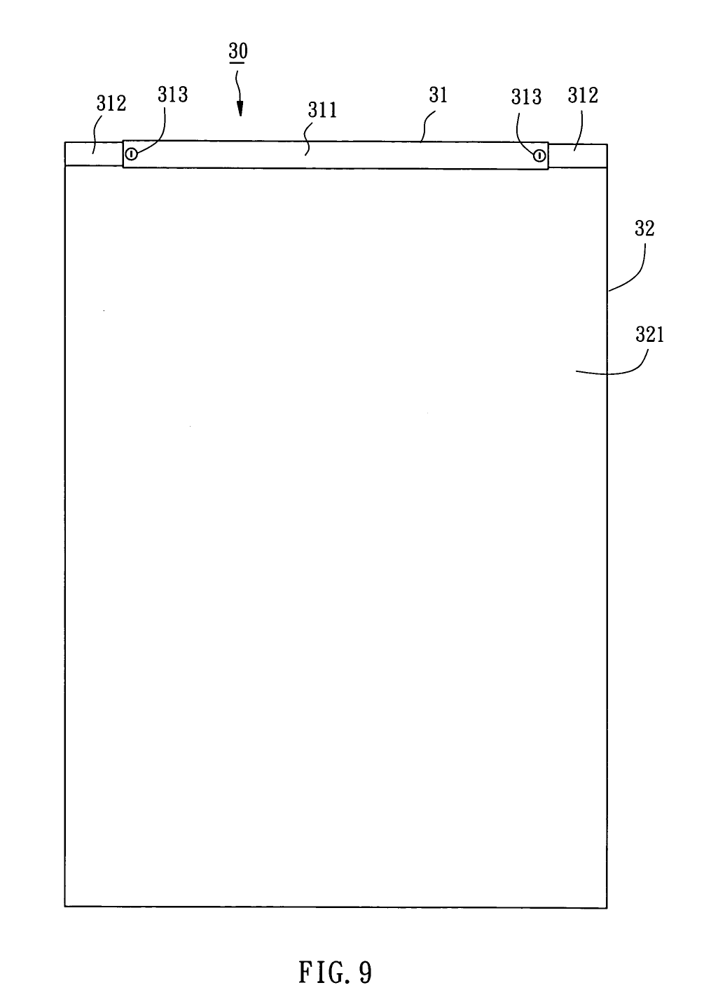

FIGS. 9-11 show a width-adjustable Roman shade 30 constructed according to the third preferred embodiment of the present invention. The width-adjustable Roman shade 30 comprises a headrail 31 installed in the top side of the window (not shown), a shade cloth 32, which comprises a cloth body 321, a plurality of elongated pockets 322 transversely provided at the back side of the cloth body 321 at different elevations, and a plurality of cord-guiding loops 323 respectively provided at the pockets 322 on the outside and arranged into two vertical lines, a plurality of support rods 33 respectively inserted into the pockets 322 to support the cloth body 321 transversely (horizontally) in shape, two lift cords 34 each having one end tied to the lowest one of one of the two vertical lines of the cord-guiding loops 323 and the other end inserted through the others of the respective vertical line of the cord-guiding loops 323 and then coupled to the headrail 31 for controlling lifting and lowering of the bottom side of the cloth body 321, and a plurality of coupling units 35.

The support rods 33 and lift cords 34 of this third embodiment are substantially similar to those of the aforesaid first embodiment. The main feature of this third embodiment is outlined hereinafter. As shown in FIG. 9, the headrail 31 comprises a first headrail element 311, two second headrail elements 312, and two locking devices 313. The first headrail element 311 and the second headrail elements 312 are narrow elongated elements. The first headrail element 311 has an internal contour fitting the external contour of the second headrail elements 312 such that the second headrail elements 312 are axially movable in and out of the two distal ends of the first headrail element 311. The locking devices 313 according to this embodiment each are a tightening up screw perpendicularly mounted in the peripheral wall of the first headrail element 311 and stoppable against the periphery of the second headrail elements 312 respectively to hold down the second headrail elements 312 in position by means of friction resistance.

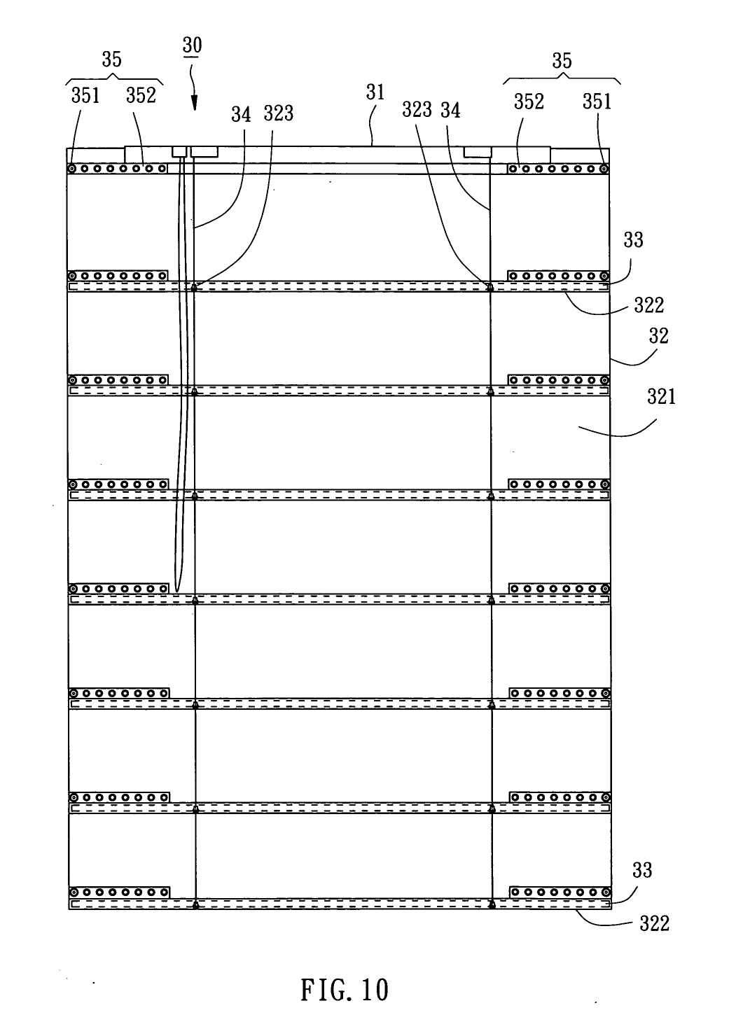

As shown in FIG. 10, the coupling units 35 are arranged into two symmetrical sets and symmetrically transversely provided at the back side of the cloth body 321 at different elevations near the two opposite lateral sides of the cloth body 321. Each coupling unit 35 is comprised of a male snap element 351 provided near one lateral side edge of the cloth body 321 and a plurality of female snap elements 352 transversely aligned with the male snap element 351 in a line. By means of turning one lateral side edge of the cloth body 321 backward to fasten the male snap element 351 of each coupling unit 35 to one respective female snap element 352, the width (transverse length) of the shade cloth 32 is relatively adjusted.

As shown in FIG. 11, the support rods 33 are wooden or plastic rod members each having a plurality of parallel grooves 331 extended around the periphery and symmetrically disposed near the two distal ends. When adjusting the width (transverse length) of the width-adjustable Roman shade 30, the user can break each support rod 33 at one groove 331.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A shade cloth for a Roman shade, said shade cloth comprising:
a cloth body having a front side, a back side, and two opposite lateral side edges; and
a coupling unit provided at the back side of said cloth body adjacent to one of the two opposite lateral side edges for securing said one of the two opposite lateral side edges to the back side of said cloth body so as to adjust transverse length of said cloth body.

2. The shade cloth as claimed in claim 1, wherein said coupling unit comprises a male snap element and a plurality of female snap elements transversely aligned with said male snap element and connectable to said male snap element.

3. The shade cloth as claimed in claim 1, wherein said coupling unit comprises a first coupling element and a second coupling element that is aligned transversely with said first coupling element and is connectable to said first coupling element.

4. The shade cloth as claimed in claim 3, wherein said first coupling element and said second coupling element are respectively hook and loop tapes of a hook and loop fastener.

5. The shade cloth as claimed in claim 1, comprising a plurality of said coupling units that are arranged at the back side of said cloth body at different elevations.

6. The shade cloth as claimed in claim 1, comprising at least one pair of said coupling units; wherein said coupling units are symmetrically respectively arranged adjacent the two opposite lateral side edges of said cloth body.

7. The shade cloth as claimed in claim 1, wherein said cloth body comprises a plurality of elongated pockets transversely arranged at the back side of said cloth body at different elevations, and a plurality of support rods respectively inserted into said pockets to support said cloth body transversely.

8. The shade cloth as claimed in claim 7, wherein said cloth body further comprises a plurality of cord-guiding loops respectively provided at said pockets and vertically aligned in two lines.

9. The shade cloth as claimed in claim 7, wherein said support rods each comprise a tubular outer rod member and an inner rod member slidably inserted into the tubular outer rod member.

10. The shade cloth as claimed in claim 7, wherein said support rods are breakable rod members each having a plurality of spaced grooves extended near one of two distal ends thereof.

11. A Roman shade comprising:
a headrail;
a cloth body connected to and suspended from said headrail, said cloth body having a front side, a back side, and two opposite lateral side edges; and
a coupling unit provided at the back side of said cloth body adjacent to one of the two opposite lateral side edges for securing said one of the two opposite lateral side edges to the back side of said cloth body so as to adjust transverse length of said cloth body.

12. The Roman shade as claimed in claim 11, wherein said headrail comprises a first headrail element, and a second headrail element axially movable in and out of said first headrail element; said coupling unit is provided at the back side of said cloth body corresponding to said second headrail element.

13. The Roman shade as claimed in claim 12, further comprising a fastening unit for securing said cloth body to said headrail, said fastening unit comprising a first fastener provided at the front side of said cloth body and extended along a top side edge of said cloth body, a second fastener provided at a back side of said first headrail element and connectable to said first fastener, and a third fastener provided at a back side of said second headrail element and connectable to said first fastener.

14. The Roman shade as claimed in claim 11, wherein said coupling unit comprises a male snap element and a plurality of female snap elements transversely aligned with said male snap element and connectable to said male snap element.

15. The Roman shade as claimed in claim 11, wherein said coupling unit comprises a first coupling element and a second coupling element that is aligned transversely with said first coupling element and is connectable to said first coupling element.

16. The Roman shade as claimed in claim 15, wherein said first coupling element and said second coupling element are respectively hook and loop tapes of a hook and loop fastener.

17. The Roman shade as claimed in claim 11, comprising a plurality of said coupling units that are arranged at the back side of said cloth body at different elevations.

18. The Roman shade as claimed in claim 11, comprising at least one pair of said coupling units; wherein said coupling units are symmetrically respectively arranged adjacent the two opposite lateral side edges of said cloth body.

19. The Roman shade as claimed in claim 11, wherein said cloth body comprises a plurality of elongated pockets transversely arranged at the back side of said cloth body at different elevations, and a plurality of support rods respectively inserted into said pockets to support said cloth body transversely.

20. The Roman shade as claimed in claim 19, wherein said cloth body further comprises a plurality of cord-guiding loops respectively provided at said pockets and vertically aligned in two lines.

21. The Roman shade as claimed in claim 19, wherein said support rods each comprise a tubular outer rod member and an inner rod member slidably inserted into the tubular outer rod member.

22. The Roman shade as claimed in claim 19, wherein said support rods are breakable rod members each having a plurality of spaced grooves extended near one of two distal ends thereof.
